(19) United States
(12) Patent Application Publication
(10) Pub. No.: US 2009/0104439 A1
(43) Pub. Date: Apr. 23, 2009

(54) CELLULOSE ESTER FILM AND PROCESS FOR PRODUCING THE SAME

(76) Inventor: Hideo Sugimoto, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/293,368

(22) PCT Filed: Mar. 7, 2007
(86) PCT No.: PCT/JP2007/054417

§ 371 Date: Sep. 17, 2008

(30) Foreign Application Priority Data
Mar. 22, 2006 (JP) 2006-079385

(51) Int. Cl. B32B 5/16; C08L 1/08

(52) U.S. Cl. 428/331; 524/600

(57) ABSTRACT

In the production process of a cellulose ester film, fine particles are added in the step of dissolving a cellulose ester resin in a main solvent at a temperature at or below the boiling point of the main solvent under the atmospheric pressure, and, after the addition, mixing is carried out at a temperature at or above the boiling point of the main solvent. Preferably, the mixing is carried out in a temperature range of the boiling temperature of the main solvent to a temperature of (boiling point of the main solvent+50° C.) for not less than 60 min and not more than 300 min.

### TECHNICAL FIELD

The present invention relates to a cellulose ester film especially suitable as a protection film of a polarizing plate of a liquid crystal display device and a retardation film and a producing method of this film.

### BACKGROUND ART

In recent years, in association with the circumstances that liquid crystal display devices (LCD) are used at various places, high visibility at the time of viewing an image has been demanded. Especially, high image quality without spot defects due to foreign matters and flatness like a glass have been demanded for a polarizing plate and a retardation plate. Further, in a LCD used at outdoors like a car navigation device or PDA, it is necessary to make a polarizing plate protective film contain an ultraviolet absorber in order to prevent deterioration of a polarizer.

Herein, at the present day, cellulose triacetate (TAC) films have been mainly used as protective films of polarizing plates used for LCD. Owing to the popularization of television or monitors and the tendency to make a screen larger, in the film especially used at the uppermost surface, high flatness and high image quality have been demanded. Therefore, since spot defects causes image defects, it leads to the debasement of LCD.

Further, in resin films used for LCD, films adhere easily to each other due to transparency and smoothness. Therefore, in order to improve handling easiness and to stabilize winding properties, fine particles are added into films at the time of forming film and processing the surface of the films so as to provide smoothness to the films without spoiling the transparency of the films.

The cellulose ester film is usually produced by the solution casting film forming method. That is, dope (thick solution) of cellulose ester is cast on an endless support from a casting die. After the cast dope exhibits a self-supporting ability, the cast dope is peeled off from the endless belt, whereby a film is produced. In many cases, the film contains additives such as a matting agent, a plasticizer, and an ultraviolet absorber other than the cellulose ester. The matting agent is used to improve of the smoothness and adhesive resistance of the produced film, and the ultraviolet absorber is used, for example, for the deterioration prevention of a polarizing plate when the film is used for the polarizing plate. These components are usually mixed together at the time of preparing dope.

Herein, in association with the tendency that cellulose ester film is made thinner, it becomes easy to cause a sticking failure in which films adhere to each other and deform and a convex deforming failure in which films deform in convex like a situation that a foreign matter is caught between films.

Further, in association with a request for high image quality in recent years, a level to allow film to contain foreign matters became sever such that small foreign matters which have been deemed no problem until now became to be regarded as problems. For example, when a foreign matter observed with a size of 50 μm s analyzed by the use of an electron microscope, the size of the core of the foreign matter is about several micrometers. Therefore, it turned out that since the circumference of the foreign matter rises up, the foreign matter looks with a larger size visually. Moreover, it also turned out that almost all foreign matters forming a core are aggregates of fine particles. Therefore, it was difficult to satisfy both requirements to improve a sliding ability by the increase of the additive amount of fine particles and to reduce foreign matter failures by the removing of only aggregates of fine particle having a size of several micrometers or more.

Further, for example, there are occurrences of problems such as deformation of a film at a winding-up process and adhesion among films when the films has been kept for a long time on the condition that a lengthy film is wound up in a roll, and there are occurrences of blocking as a severe case.

Especially, when the width of a base film of a cellulose ester film is made wider so as to become 1.4 m or more, the effect of knurling provided at both sides of the film becomes small. As a result, there is a problem that the storage stability of the base film gets worse easily.

Further, there are problems that when such films are used in a manufacturing process of a polarizing plate, a portion where films adhere to each other deform, and the deformation causes pasting unevenness in pasting with a polarizing plate and coating unevenness at a coating process.

Here, the following are precedence patent documents in connection with the cellulose ester film used for the conventional polarizing plate protective films.

In order to prevent occurrences of sticking failures in which films adhere to each other such that the film deform, Patent documents 1 discloses a technique in which a matting agent is dispersed in a solvent, this dispersion is added in a solution containing an ultraviolet absorber so as to produce a fine particle additive liquid and this liquid is added into a main dope of cellulose ester resin by in-line.

Further, Patent documents 2 discloses a cellulose triacetate film producing method in which a dope prepared beforehand by a process of dissolving cellulose triacetate in a solvent is mixed with a dispersion prepared beforehand by a process of dispersing fine particles having a methyl group on their surfaces to a solvent or a mixed solution of a solvent or and cellulose triacetate, and then the mixed liquid is cast on a support and is dried.

Further, in a solution film forming producing method of mixing a matting agent in a dope having dissolved polymer and casting the dope so as to form a film, Patent documents 3 discloses a solution film forming producing method comprising a first process of detecting an amount of matting agents in the formed film and a second process of adjusting the amount of the matting agents to be mixed into the dope based on the detected amount of the matting agents at the first process.

Further, in a producing method of cellulose ester film containing fine particles, Patent documents 4 a cellulose ester film producing method in which an additive liquid containing fine particles is added into a main dope, after that, the dope is filtered with a filtering medium having a collecting particle size of 0.5 to 5 μm and a filtering time of 10 to 25 sec/100 ml and the filtered dope is cast so as to form a film.

Patent Documents 1: Japanese Patent Unexamined Publication No. 2001-114907

Patent Documents 2: Japanese Patent Unexamined Publication No. 7-11055

Patent Documents 3: Japanese Patent Unexamined Publication No. 2003-291161

Patent Documents 4: Japanese Patent Unexamined Publication No. 2005-178239

### DISCLOSURE OF THE INVENTION

### Problem to be Solved by the Invention

However, according to the technique of the above-mentioned Patent documents 1, there are problems that when fine particle additive liquid is filtered with a fine filter in order to reduce foreign matters, aggregates of fine particles adhere to each other on the filter and further aggregate, and the filter is clogged with the aggregates of fine particles and the filtration pressure often rises rapidly. Moreover, by the method of Patent documents 1, fine particle aggregation occurs further with a shock generated when the fine particle additive liquid is added into the main dope by in-line and this is not able to be removed.

Further, according to the method of the above-mentioned Patent documents 2, there are problems that although the fine particles are limited to fine particles having a methyl group, since a filtering amount of the dope until a pressure loss reaches to a predetermined value is small, the method is not suitable for the productivity and is not said to be sufficient.

Further, according to the method of the above-mentioned Patent documents 3, there are problems that although the amount of fine particles in the formed film is detected and the detected amount is fed back to a setup of the additive amount of fine particles, the detection of the amount of fine particles in the film after the film formation causes time lag of about several hours regardless of in-line, variations in the amount at the preparation stage of film materials cannot be suppressed perfectly.

Lastly, in Patent document 4, there are problems that although the filter medium (filter paper) specified with the collecting particle size and the filtering time, the themes cannot be solved only by the removing of aggregates of fine particles by the filter medium (filter paper), and the method is not sufficient under the present situation that the production of a cellulose ester film as an optical film is required to be high productivity with high quality in recent years.

An object of the present invention is to solve the above problems and to provide a method of producing a cellulose ester film having no occurrence of foreign matters and excellent in productivity by suppressing a foreign material occurrence rate due to the addition of fine particles contained in a cellulose ester resin solution (dope) in a process of dissolving and mixing a dope and reducing a load to a filter at a filtering process after the above process, and to provide a cellulose ester film produced by the method.

### Means for Solving the Problem

In order to achieve the above-mentioned object, the invention of claim 1 is characterized in that in a cellulose ester film producing method of producing a film by the use of a cellulose ester resin solution containing fine particles by a solution casting film producing method, fine particles are added in a process of dissolving the cellulose ester resin into a main solvent at a temperature of a boiling point of the main solvent or less and atmospheric pressure, and the solution and the fine particles are mixed at a temperature of the boiling point or more after the fine particles were added.

The invention of claim 2 is, in the cellulose ester film producing method described in claim 1, characterized in that the mixing of fine particles in the cellulose ester resin dissolving process is conducted at a temperature of the boiling point of the main solvent or more and (the boiling point−50° C.) or less.

The invention of claim 3 is, in the cellulose ester film producing method described in claim 1, characterized in that the mixing of fine particles in the mixing of the fine particles in the cellulose ester resin dissolving process is conducted for a time period of 60 minutes or more and 300 minutes or less.

The invention of claim 4 is, in the cellulose ester film producing method described in any one of claims 1 to 3, characterized in that after the fine particles were added, a pressure is added so as to suppress foaming in the process of mixing at a temperature of a boiling point of the main solvent or more.

The invention of claim 5 is, in the cellulose ester film producing method described in any one of claims 1 to 4, characterized in that after the fine particles were added, a pressure is added to from 0.11 to 1.50 MPa at 40.4 to 120° C. in the process of mixing at a temperature of a boiling point of the main solvent or more.

The invention of claim 6 is, in the cellulose ester film producing method described in any one of claims 1 to 5, characterized in that fine particles added in the cellulose ester resin dissolving process are added during the adding of the cellulose ester resin into a dissolving tank, after the adding, or before the cellulose ester resin is dissolved completely in the dissolving tank.

The invention of claim 7 is, in the cellulose ester film producing method described in claim 1, characterized in that a fine particle dispersion liquid is prepared beforehand, the fine particle dispersion liquid is made to contain a compound represented by Formula (1), and subsequently the fine particle dispersion liquid containing the compound is added in the process of dissolving the cellulose ester resin into the main solvent.

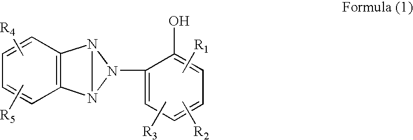

(in the formula, R₁, R₂, R₃, R₄ and R₅ are the same to or different from each other and each represents substituent selected from a group consisting of a hydrogen atom, a halogen atom, a nitro group, a hydroxyl group, an alkyl group, an alkenyl group, an aryl group, an alkoxy group, an acyloxy group, an aryloxy group, an alkylthio group, an arylthio group, and a mono or di alkylamino group, an acyl amino group, and a five or six member heterocycle group containing oxygen or nitrogen, and R₄ and R₅ may form a five or six member ring being a closed ring composed of carbon atoms.)

The invention of claim 8 is, in the cellulose ester film producing method described in claim 1, characterized in that a fine particle dispersion liquid is prepared beforehand, the same resin as the cellulose ester resin is dissolved and mixed in the fine particle dispersion liquid, and the solid component ratio of the fine particle dispersion liquid is 0.1 to 0.5 times of the solid component ratio of the cellulose ester resin solution (dope) being dissolved in the dissolving process.

The invention of claim 9 is, in the cellulose ester film producing method described in claim 1, characterized in that the fine particles are fine particles incapable of being dissolved in the main solvent.

The invention of claim 10 is, in the cellulose ester film producing method described in claim 9, characterized in that the fine particles are silicon dioxide fine particles.

The invention of claim 11 is, in the cellulose ester film producing method described in claim 10, characterized in that the cellulose ester resin solution (dope) containing the silicon dioxide fine particles added in the cellulose ester resin dissolving process is made to pass through a filter paper having a colleting particle size of 2.5 μm, a film is formed by the use of the solution obtained by the filtering, and the collecting ratio of secondary fine particles including the silicon dioxide fine particles by the filter paper is 5% or less.

The invention of claim 12 is a cellulose ester film produced by the cellulose ester film producing method described in any one of claims 1 to 11, characterized in that the variation coefficient of fine particles (average particle diameter/standard deviation) in a cross section of a cut-out piece of the cellulose ester film is 50% or less in the particle diameter measurement of fine particles by the use of a transmission electron microscope.

The invention of claim 13 is, in the cellulose ester film described in claim 12, characterized in that in the particle diameter measurement of fine particles by the use of a transmission electron microscope in a cross section of a cut-out piece of the cellulose ester film, the variation coefficient (average particle diameter/standard deviation) of fine particles is 50% or less.

The invention of claim 14 is, in the cellulose ester film described in claim 12 or 13, characterized in that in the particle diameter measurement of fine particles by the use of a transmission electron microscope in a cross section of a cut-out piece of the cellulose ester film, the particle diameter measurement is a measurement for secondary fine particles, a primary particle diameter is 20 nm or less and a secondary particle diameter is 150 nm to 250 nm.

The invention of claim 15 is, in the cellulose ester film described in any one of claims 12 to 14, characterized in that the haze of the cellulose ester film is 0 to 0.5% and the dynamic friction coefficient of a back side surface is 0.5 to 0.7.

### EFFECT OF THE INVENTION

In the invention of the cellulose ester film producing method described in claim 1, fine particles are added in a process of dissolving the cellulose ester resin into a main solvent at a temperature of a boiling point of the main solvent or less and atmospheric pressure, and the solution and the fine particles are mixed at a temperature of the boiling point or more after the fine particles were added. According to the invention, it is possible to obtain the effects that the foreign matter generating rate due to the addition of fine particles contained in the cellulose ester resin solution (dope) can be suppressed in the dope dissolving and mixing process, the load on a filter in a filtering process after that process can be reduced and the cellulose ester film having no occurrence of foreign matters and excellent in productivity can be produced. Further, since the fine particles are added at atmospheric pressure, it can be possible to obtain the effect that there is no problem that dope flows reversely by an added pressure and the cellulose ester film excellent in productivity can be produced.

In the invention of claim 2, in the cellulose ester film producing method described in claim 1, the mixing of fine particles in the cellulose ester resin dissolving process is conducted at a temperature of the boiling point of the main solvent or more and (the boiling point−50° C.) or less. According to the present invention, it can be possible to obtain the effects that by specifying the mixing temperature of fine particles in the cellulose ester resin dissolving process to a temperature of (a boiling point of main solvent+50° C.) or less, the foreign matter generating rate in the dope dissolving mixing process can be surely suppressed and the cellulose ester film having no occurrence of foreign matters and excellent in optical characteristic can be produced. Further, since the temperature of (a boiling point of main solvent+50° C.) is a marginal heating temperature, it can be possible to obtain the effects that the cellulose ester film excellent in productivity can be produced.

In the invention of claim 3, in the cellulose ester film producing method described in claim 1 or 2, the mixing of fine particles in the mixing of the fine particles in the cellulose ester resin dissolving process is conducted for a time period of 60 minutes or more and 300 minutes or less. According to the invention, it is possible to obtain the effects that by specifying the mixing time of the fine particles in the cellulose ester resin dissolving process, there is no deterioration in a variation coefficient (distribution) of the fine particles in a cellulose ester film and it is preferable from the viewpoint of production suitability. If the time is less than 60 minutes other than the above specified time, the mixing is not conducted sufficiently, and if the time is more than 300 minutes, the fine particles becomes too small. As a result, since the desired effects cannot be obtained, it is not preferable.

In the invention of claim 4, in the cellulose ester film producing method described in any one of claims 1 to 3, a pressure is added so as to suppress foaming in the process of mixing at a temperature of a boiling point of the main solvent or more. Therefore, according to the present invention, by suppressing foaming, the mixing can be conducted efficiently in a short time.

In the invention of claim 5, in the cellulose ester film producing method described in any one of claims 1 to 4, a pressure is added to from 0.11 to 1.50 MPa at 40.4 to 120° C. in the process of mixing at a temperature of a boiling point of the main solvent or more. Therefore, according to the present invention, by specifying the temperature and the pressure, foaming is suppressed and the mixing can be conducted efficiently in a short time.

In the invention of claim 6, in the cellulose ester film producing method described in any one of claims 1 to 5, fine particles added in the cellulose ester resin dissolving process are added during the adding of the cellulose ester resin into a dissolving tank, after the adding, or before the cellulose ester resin is dissolved completely in the dissolving tank. Therefore, according to the present invention, it is possible to obtain the effects that by specifying the timing of adding the fine particles in the cellulose ester resin dissolving process, the foreign matter generating rate due to the addition of the fine particles contained in the cellulose ester resin solution (dope) can be surely suppressed in the dope dissolving mixing process, the load on the filter in the filtering process after the dope dissolving mixing process can be greatly reduced and the cellulose ester film having no occurrence of foreign matters and excellent in productivity can be produced.

In the invention of claim 7, in the cellulose ester film producing method described in claim 1, a fine particle dispersion liquid is prepared beforehand, the fine particle dispersion liquid is made to contain a compound represented by Formula (1), and subsequently the fine particle dispersion liquid containing the compound is added in the process of dissolving the cellulose ester resin into the main solvent. Therefore, according to the present invention, it is possible to obtain the effects that by making the fine particle dispersion liquid contain the specified compound having a function of an ultraviolet absorber and by adding the fine particle dispersion liquid containing the compound in the process of dissolving the cellulose ester resin into the main solvent, the distribution of particle size in secondary aggregation of fine particles is mono-dispersed more, the haze value of the obtained cellulose ester film becomes low, and the number of foreign matters to be collected by a filter paper in the filtering process after the process becomes small, therefore, it is effective in the viewpoint of a filter life and it can contribute to the improvement of the productivity.

In the invention of claim 8, in the cellulose ester film producing method described in claim 1, a fine particle dispersion liquid is prepared beforehand, the same resin as the cellulose ester resin is dissolved and mixed in the fine particle dispersion liquid, and the solid component ratio of the fine particle dispersion liquid is 0.1 to 0.5 times of the solid component ratio of the cellulose ester resin solution (dope) being dissolved in the dissolving process. Therefore, according to the present invention, it is possible to obtain the effects that by specifying the solid component ratio of the same resin as the cellulose ester resin dissolved and mixed in the fine particle dispersion liquid to be added in the cellulose ester resin dissolving process, the addition of the fine particles can be conducted smoothly, the foreign matter generating rate due to the addition of the fine particles can be surely suppressed in the dope dissolving mixing process, and the cellulose ester film having no occurrence of foreign matters and excellent in productivity can be produced.

In the invention of claim 9, in the cellulose ester film producing method described in claim 1, the fine particles are fine particles incapable of being dissolved in the main solvent. Therefore, according to the present invention, preferable particles can be selected as the fine particles from the fine particles incapable of being dissolved in the main solvent.

In the invention of claim 10, in the cellulose ester film producing method described in claim 9, the fine particles are silicon dioxide fine particles. Therefore, according to the present invention, it is possible to obtain the effects that by adding the silicon dioxide (silica) fine particles in the cellulose ester resin dissolving process, preferably, in the middle course of adding and dissolving cellulose ester resin in a main solvent, there is an effect to prevent extremely the occurrence of foreign matter failure deemed to be caused by aggregation generated by shock at the time of conventionally adding fine particles by in-line at the time of producing cellulose ester, and the cellulose ester film having no occurrence of foreign matters and excellent in productivity can be produced.

In the invention of claim 11, in the cellulose ester film producing method described in claim 10, the cellulose ester resin solution (dope) containing the silicon dioxide fine particles added in the cellulose ester resin dissolving process is made to pass through a filter paper having a colleting particle size of 2.5 μm, a film is formed by the use of the solution obtained by the filtering, and the collecting ratio of secondary fine particles including the silicon dioxide fine particles by the filter paper is 5% or less. Therefore, according to the present invention, it is possible to obtain the effects that by using the specified filter paper and by specifying the collecting ratio of secondary fine particles in the filtering process for the dope containing the silicon dioxide fine particles added in the cellulose ester resin dissolving process, the number of foreign matters can be greatly reduced and the cellulose ester film excellent in productivity can be produced.

In the invention of claim 12, in the cellulose ester film produced by the cellulose ester film producing method described in any one of claims 1 to 11, the variation coefficient of fine particles (average particle diameter/standard deviation) in a cross section of a cut-out piece of the cellulose ester film is 50% or less in the particle diameter measurement of fine particles by the use of a transmission electron microscope. Therefore, according to the present invention, it is possible to obtain the effects that the distribution of the fine particles contained in the cellulose ester film is good, there is no occurrence of the generation of foreign matters, and the optical characteristic is excellent.

In the invention of claim 13, in the cellulose ester film described in claims 12, in the particle diameter measurement of fine particles by the use of a transmission electron microscope in a cross section of a cut-out piece of the cellulose ester film, the variation coefficient of fine particles (average particle diameter/standard deviation) is 30% or less. Therefore, according to the present invention, it is possible to obtain the effects that by specifying the variation coefficient (average particle diameter/standard deviation) of fine particles contained in the cellulose ester film, the distribution of the fine particles contained in the cellulose ester film is very good, there is no occurrence of the generation of foreign matters, and the optical characteristic is excellent.

In the invention of claim 14, in the cellulose ester film described in claims 12 or 13, in the particle diameter measurement of fine particles by the use of a transmission electron microscope in a cross section of a cut-out piece of the cellulose ester film, the particle diameter measurement is a measurement for secondary fine particles, a primary particle diameter is 20 nm or less and a secondary particle diameter is 150 nm to 250 nm. Therefore, according to the present invention, it is possible to obtain the effects that by specifying the primary particle diameter and the secondary particle diameter to a specific one, there is no occurrence of the generation of foreign matters, and the cellulose ester film is excellent in the optical characteristic.

In the invention of claim 15, in the cellulose ester film described in any one of claims 12 to 14, the haze of the cellulose ester film is 0 to 0.5% and the dynamic friction coefficient of a back side surface is 0.5 to 0.7. Therefore, according to the present invention, it is possible to obtain the effects that by specifying the haze of the cellulose ester film to a specific one, the transparency of the film is excellent, and by specifying the dynamic friction coefficient of the back side surface to a specific one, the sliding ability becomes good and films hardly adhere to each other, therefore, the handling ability at the time of processing the back surface of these cellulose ester films can be improved and the winding ability can be stabilized.

### BRIEF DESCRIPTION OF THE DRAWINGS

FIG. 1 is a schematic view of an apparatus for carrying out the cellulose ester film producing method of thee present invention.

### EXPLANATION OF REFERENCE SYMBOLS

1 Dispersion liquid preparing tank
2a, 2b Liquid feeding pump
4 Cellulose triacetate dissolving tank
5 Filtering device
101 Support structured with an endless belt made of stainless steel
102 Casting die
103 Separating roll
104 Web
105 Tentar•drying device
106 Roll conveyance•drying device
107 Winding up device

### BEST MODE FOR CARRYING OUT THE INVENTION

Hereinafter, the best mode for carrying out the invention will be explained. However, the present invention is not limited to these.

The cellulose ester film producing method of the present invention is a cellulose ester film producing method of forming a film by a solution casting film forming method by the use of a cellulose ester resin solution containing fine particles, and the cellulose ester film producing method adds fine particles in a process of dissolving cellulose ester resin in a main solvent at a temperature of a boiling point of the main solvent or less under atmospheric pressure, and after the adding, mixes the fine particles at a temperature of a boiling point of the main solvent or more.

Hereafter, the cellulose ester film producing method of the present invention will be explained in detail.

As the cellulose ester usable in the method of the present invention, cellulose ester synthesized from cotton linter, cellulose ester synthesized from wood pulp, cellulose ester synthesized from the other raw materials may be used solely or as a mixture of them.

As the cellulose ester usable in the present invention, the lower fatty acid ester of cellulose is used preferably.

A low fatty acid in the lower fatty acid ester represents a fatty acid having a carbon number of 6 or less. Examples of the lower fatty acid ester include cellulose acetate, cellulose propionate and cellulose butyrate; and mixed fatty acid ester of cellulose acetate propionate, cellulose acetate butylate and the like described in JPA Nos. 10-45804, 8-231761 and U.S. Pat. No. 2,319,052.

The degree of substitution of acyl group in cellulose ester can be measured in accordance with ASTM-D-817-96.

Among the above fatty acids, cellulose acetate and cellulose acetate propionate are preferably used. However, in the case of the cellulose ester film of the present invention, a fatty acid having a polymerization degree of 250 to 400 is preferably used from the viewpoint of film strength.

In the cellulose ester film of the present invention, cellulose ester having the total acyl group substitution degree of 2.5 to 3.0 is preferably used, in particular, cellulose ester having the total acyl group substitution degree of 2.55 to 2.85 is preferably used. More preferably, if the total acyl group substitution degree is 2.55 or more, the mechanical strength of a film increases, and if the total acyl group substitution degree is 2.85 or less, the solubility of cellulose ester is improved and the occurrence of foreign matters is reduced.

In the case of being used a polarizing protective film, cellulose acetate is more preferable. The molecular weight distribution Mw/Mn in which a weight average molecular weight Mw is divided by a number average molecular weight is preferably 1.8 to 3.0.

A solvent used at the time of producing a main dope, as far as a solvent can dissolve a cellulose ester, the solvent is not restricted. Further, even if a solvent can not dissolve it with itself solely, if the solvent can dissolve it when the solvent is mixed with other solvent, the solvent can be used. Generally, it is preferable to use a mixed solvent of a methylene chloride being a good solvent and a cellulose ester being a poor solvent and to contain the poor solvent of 4 to 30% by weight in the mixed solvent.

In addition, as a usable good solvent, for example, methylene chloride, methyl acetate, ethylacetate, amyl acetate, methyl acetoacetate, acetone, tetrahydrofuran, 1,3-dioxolane, 1,4-dioxane, cyclohexanone, ethyl formate, 2,2,2-trifluoro ethanol, 2,2,3,3-tetrafluoro-1-propanol, 1,3-difluoro-2-propanol, 1,1,1,3,3, and 3-hexafluoro-2-methyl-2-propanol, 1,1,1,3,3, and 3-hexafluoro-2-propanol, 2,2,3 and 3, and 3-pentafluoro-1-propanol, nitroethane, 1, and 3-dimethyl-2-imidzolinon etc. may be employed, however, organic halogenated compounds, such as methylene chloride, a dioxysolan derivative, methyl acetate, ethylacetate, acetone, etc. may be listed up as a desirable organic solvent (namely, good solvent). When methyl acetate is used, since curl of obtained film becomes small, it is particularly preferable.

As a poor solvent of cellulose ester, for example, an alcohol having a carbon number of 1-8, such as methanol, ethanol, n-propanol, iso-propanol, n-butanol, sec-butanol, and tert-butanol, methyl ethyl ketone, methyl isobutyl ketone, an ethylacetate, propyl acetate, mono-chloro benzene, benzene, cyclohexane, tetrahydrofuran, methyl cellosolve, ethylene glycol monomethyl ether, etc. can be mentioned. These poor solvents may be used solely or as a mixture combined two or more solvents appropriately.

In the cellulose ester resin dissolving process, the recycled material of cellulose ester film may used together with cellulose ester resin. The used ratio of the recycled material may be preferably 0 to 70% by weight to a solid component of formula values such as a main dope solution, more preferably 10 to 50% by weigh, still more preferably 20 to 40% by weight. The more the used amount of the recycled material is, the more excellent a filtering ability becomes, on the other hand, the fewer the used amount of the recycled material is, the more excellent a sliding ability becomes. Therefore, it is preferable to make the used ratio within the above range.

Here, the recycled material is chips into which cellulose ester film was pulverized finely. As the cellulose ester film for the recycled material, film materials generated at the time of producing a cellulose ester film, such as cut-out materials of both ends of a film and a cellulose ester film becoming out of a specification are used.

When using the recycled material, an amount of additives included in a cellulose ester film, such as a UV absorber and a plasticizer may be reduced in accordance with a used amount of the recycled material such that a final composition of a cellulose ester film is adjusted to become designed values.

In the cellulose ester film producing method of the present invention, fine particles are added in a process of dissolving cellulose ester resin in a main solvent at a temperature of a boiling point of the main solvent or less, and after the adding, the fine particles are mixed at a temperature of the boiling point of the main solvent or more.

As fine particles usable in the present invention, a silicon dioxide, titanium dioxide, aluminium oxide, zirconium oxide, calcium carbonate, calcium carbonate, talc, clay, a baked caolin, a baked calcium silicate, hydration silicic acid calcium, aluminium silicate, magnesium silicate, and calcium phosphate can be mentioned as an example of an inorganic compound. Since turbidity becomes low, particles containing silicon is desirable, and especially a silicon dioxide is desirable.

Fine particles of a silicon dioxide having a primary average grain diameter of 20 nm or less and an apparent specific gravity of 70 or more g/L are desirable. Particles having a primary average grain diameter of 5 to 16 nm are more desirable. Particles having a primary average grain diameter of 5 to 12 nm are still more desirable. A smaller average diameter of primary particles is desirable, because a haze is low. An apparent specific gravity of 90 to 200 g/L or more is more desirable, and 100 to 200 g/L or more is more desirable. A lager apparent specific gravity is desirable, because it becomes possible to make high-concentration fine particle dispersion liquid, and a haze and an aggregate may improve.

The additive amount of fine particles is desirably 0.02 to 1.0 g per 1 m², more desirably 0.03 to 0.3 g per 1 m², and still more desirably 0.08 to 0.2 g per 1 m².

For example, with regard to the additive amount of silicon dioxide fine particles to cellulose ester, silicon dioxide fine particles are desirably 0.01 to 5.0% by weight to cellulose ester, more desirably 0.05 to 1.0% by weight, still more desirably 0.1 to 0.6% by weight. The more, the additive amount is, the more excellent, the dynamic friction coefficient is. The smaller, the additive amount is, the smaller, aggregate is.

As fine particles of silicon dioxide, fine particles marketed by product names of Aerosil R972, R972V, R974 and R812, 200, 200V and 300, R202, OX50, and TT600 (manufactured by Japanese Aerosil Co.) can be employed, for example. As fine particles of zirconium oxide, fine particles marketed by product names of Aerosil R976 and R811 (manufactured by Japanese Aerosil Co.) can be used, for example.

In the cellulose ester film manufacturing method of the present invention, fine particles are preferably silicon dioxide fine particles. In the present invention, by adding the silicon dioxide (silica) fine particles in the cellulose ester resin dissolving process, preferably, in the middle course of adding and dissolving cellulose ester resin in a main solvent, there is an effect to prevent extremely the occurrence of foreign matter failure deemed to be caused by aggregation generated by shock at the time of conventionally adding fine particles by in-line at the time of producing cellulose ester, and the cellulose ester film having no occurrence of foreign matters and excellent in productivity can be produced.

As examples of polymer fine particles, a silicone resin, a fluorine resin, and acryl resin can be mentioned. Among them, a silicone resin is desirable, and especially fine particles having a three dimensional network structure are desirable, for example, toss pearl 103, toss pearl 105, toss pearl 108, toss pearl 120, toss pearl 145, toss pearl 3120 and toss pearl 240 (manufactured by Toshiba Silicone Co.) can be employed.

Among the above fine particles, Aerosil 200V and Aerosil R972V are silicon dioxide fine particles having a primary average particle size of 20 nm or less and an apparent specific gravity of 70 g/L or more and are especially desirable, because these particles increase effects that the turbidity of an optical film is maintained lower and a friction factor is reduced.

Here, it is desirable that the mixing of fine particles in the cellulose ester resin dissolving process is conducted at a temperature of the boiling point of the main solvent or more and (the boiling point+50° C.) or less. In this way, by specifying the mixing temperature of fine particles in the cellulose ester resin dissolving process to a temperature of (a boiling point of main solvent+50° C.) or less, the foreign matter generating rate in the dope dissolving mixing process can be surely suppressed.

Further, it is desirable that the mixing of fine particles in the mixing of the fine particles in the cellulose ester resin dissolving process is conducted for a time period of 60 minutes or more and 300 minutes or less. In this way, by specifying the mixing time of the fine particles in the cellulose ester resin dissolving process, there is no deterioration in a variation coefficient (distribution) of the fine particles in a cellulose ester film and it is preferable from the viewpoint of production suitability.

Furthermore, it is desirable that fine particles added in the cellulose ester resin dissolving process are added during the adding of the cellulose ester resin into a dissolving tank, after the adding, or before the cellulose ester resin is dissolved completely in the dissolving tank. In this way, by specifying the timing of adding the fine particles in the cellulose ester resin dissolving process, the foreign matter generating rate due to the addition of the fine particles contained in the cellulose ester resin solution (dope) can be surely suppressed in the dope dissolving mixing process, the load on the filter in the filtering process after the dope dissolving mixing process can be greatly reduced and the cellulose ester film having no occurrence of foreign matters and excellent in productivity can be produced.

In the cellulose ester film producing method of the present invention, fine particle dispersion liquid is prepared beforehand, the fine particle dispersion liquid is added in a process of dissolving cellulose ester resin into a main solvent, and after the adding, the liquid is mixed at a temperature of a boiling point of the main solvent or more.

As the producing method of the dispersion liquid containing fine particles, the following methods may be listed up. However, it is not limited to these methods.

(Producing Method A)

After solvent and fine particles are stirred and mixed, dispersion is conducted by the use of a dispersing device. The resultant liquid is made as a fine particle dispersion liquid. The fine particle dispersion liquid is diluted with a solvent, thereafter, a small amount of cellulose ester or a main dope is added into the diluted dispersion liquid and the resultant dispersion liquid is stirred sufficiently.

(Producing Method B)

After solvent and fine particles are stirred and mixed, dispersion is conducted by the use of a dispersing device. The resultant liquid is made as a fine particle dispersion liquid. Separately, a small amount of cellulose ester or a main dope is added into a solvent and stirred sufficiently. Into this solution, the above fine particle dispersion liquid is added and stirred.

(Producing Method C)

A small amount of cellulose ester or a main dope is added into a solvent and stirred sufficiently. Into this solution, fine particles are added and dispersed by a dispersing device.

(Producing Method D)

After solvent and fine particles are stirred and mixed, dispersion is conducted by the use of a dispersing device. The resultant liquid is made as a fine particle dispersion liquid. Into this fine particle dispersion liquid, a solvent is added to form a fine particle dispersion liquid.

The fine particle dispersion liquid preferably contains a small amount of cellulose ester resin, because aggregate occurring at the time of adding into a main dope is small. Further, among the methods, the producing method A is preferable, because aggregate occurring at the time of producing dispersion liquid is small.

As the solvent used at the time of dispersing fine particles, a solvent used at the time of forming a film of cellulose ester may be employed. In particular, alcohol is preferable. Examples of the alcohol, include alcohol having a carbon number of 1 to 8, such as methanol, ethanol, n-propanol, iso-propanol, n-butanol, sec-butanol, and tert-butanol.

The concentration of fine particles at the time of mixing and dispersing fine particles and a solvent is preferably 5 to 30% by weight, more preferably 8 to 25% by weight, still more preferably 10 to 15% by weight. When the concentration of fine particle in the fine particle dispersion liquid is higher, the liquid turbidity to the added amount tends to become low, and a haze and an aggregate may improve. Therefore, the high concentration may be preferable.

The concentration of fine particles at the time of mixing and dispersing fine particles, a solvent and a small amount of resin is preferably 0.5 to 10% by weight, more preferably 1 to 5% by weight, still more preferably 1 to 3% by weight. The concentration of resin is preferably 2 to 10% by weight, more preferably 3 to 7% by weight, still more preferably 4 to 6% by weight. This range is preferable, because the dispersibility of fine particles is excellent. Here, the smaller, the content of fine particles is, the easier due to a low viscosity, the handing is. The more, the content of fine particles, the smaller, the additive amount is. As a result, since the adding into a main dope become easier, the above range is preferable.

As a dispersing device (homogenizer), a usual dispersing device can be used. The dispersing device is roughly divided into a media dispersing device and a medialess dispersing device. As a dispersing device for fine particles, the medialess dispersing device is desirable, because of low haze.

As the media dispersing device, a ball mill, a sandmill, a dieno mill, etc. are may be listed.

Although a supersonic wave type, a centrifugal type, a high-pressure type, etc. may be employed as the medialess dispersing device, a high-pressure dispersing device is desirable in the present invention. The high-pressure dispersing device is an apparatus to create a special condition such as a high shearing and a high-pressure state by making a mixed composition of fine particles and a solvent to pass at a high speed through a small tube. When processing with the high-pressure dispersing device, it is desirable that the maximum pressure condition in a small tube having a pipe diameter of 1-2000 μm in the apparatus is 9.8 MPa or more, more preferably 19.6 MPa or more. At this time, a device in which the highest arrival velocity reaches 100 m/sec. or more, or a device in which a rate of heat transfer reaches to 116 W or more is desirable.

Example of the high pressure dispersing device includes an ultra high speed homogenizer (commercial name: Microfluidizer) manufactured by Microfluidics Corporation and Nanomizer manufactured by Nanomizer Nanomizer Co., Ltd. Other than the above, Manton-Goulin type high pressure dispersing device such as a homogenizer manufactured by Izumi Food Machinery Co., Ltd and Product No. UHN-01 manufactured by Sanwa Machinery Co., Ltd. may be applicable.

The content of silica (Si) components, for example, in fine particles contained in a cellulose ester film can be obtained in such a way that the sample of a bone-dry cellulose ester film is subjected to a pretreatment with alkali fusion by a micro digest wet type cracking apparatus (sulfuric acid•nitric acid decomposition), thereafter, the content can be obtained by the analyzing of the sample by the use of ICP-AES (inductively-coupled plasma atomic emission spectroscopy apparatus).

In the cellulose ester film producing method of the present invention, it is desirable that the same resin as the cellulose ester resin is dissolved and mixed in the fine particle dispersion liquid to be added in a cellulose ester resin dissolving process, and the solid component ratio of the fine particle dispersion liquid is 0.1 to 0.5 times of the solid component ratio of the cellulose ester resin solution (dope) being dissolved in the dissolving process.

In this way, the fine particle dispersion liquid contains cellulose ester in addition to fine particles. Therefore, it may be preferable that the viscosity of the dispersion liquid can be adjusted and is excellent in stagnation stability.

Here, as the cellulose ester, the same one in a main dope can be used, and recycling materials can be used as same as the dope.

In the producing method of the cellulose ester film of the present invention, an ultraviolet absorber is added into a dope of cellulose ester resin.

An ultraviolet absorber has an object to improve durability by absorbing ultraviolet rays of 400 nm or less, and in particular, transmittance at a wavelength of 380 nm is preferably 10% or less, more preferably 5% or less and still more preferably 2% or less.

The ultraviolet absorber used for the present invention is preferably an ultraviolet absorber which is a liquid state under a temperature of 20° C. When the ultraviolet absorber being a liquid state under a temperature of 20° C. is used, since change of a retardation (Rt) in a thickness direction is small at the time of stretching a film, it is preferable.

Examples of ultraviolet absorbers used preferably include a benzotriazol type ultraviolet absorber and a benzophenone type ultraviolet absorber which have high transparency and are excellent in effect to prevent deterioration of a polarizing plate and a liquid crystal element. In particular, a benzotriazol system ultraviolet absorber with less unnecessary coloring is desirable.

Especially, in a producing method of the cellulose ester film of the present invention, it is desirable that when a fine particle dispersion liquid is prepared beforehand, the fine particle dispersion liquid is made to contain a compound represented by the following general formula [1], and subsequently the fine particle dispersion liquid containing this compound is added in a process of dissolving a cellulose ester resin in a main solvent.

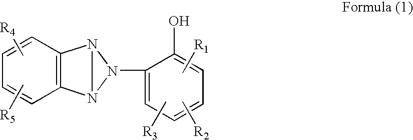

(in the formula, R₁, R₂, R₃, R₄ and R₅ are the same to or different from each other and each represents substituent selected from a group consisting of a hydrogen atom, a halogen atom, a nitro group, a hydroxyl group, an alkyl group, an alkenyl group, an aryl group, an alkoxy group, an acyloxy group, an aryloxy group, an alkylthio group, an arylthio group, and a mono or di alkylamino group, an acyl amino group, and a five or six member heterocycle group containing oxygen or nitrogen, and R₄ and R₅ may form a five or six member ring being a closed ring composed of carbon atoms.)

In this way, when a fine particle dispersion liquid is prepared beforehand, the fine particle dispersion liquid is made to contain a compound represented by the following general formula [1], and subsequently the fine particle dispersion liquid containing this compound is added in a process of dissolving a cellulose ester resin in a main solvent. Namely, according to the present invention, the fine particle dispersion liquid is made to contain a specific compound having a function as an ultraviolet absorber and the fine particle dispersion liquid containing this compound is added in a process of dissolving a cellulose ester resin in a main solvent. Therefore, distribution (coefficient of variation) of the particle size of secondary aggregate of fine particles becomes mono-dispersion more, the haze of a obtained cellulose ester film is lowered, and the number of foreign matters to be collected by a filter paper in a subsequent filtering process decreases, whereby it is effective from a viewpoint of a filter life and it is also possible to contribute to improve the productivity.

Specific examples of the ultraviolet absorbers usable in the present invention include 5-chloro-2-(3,5-di-sec-butyl-2-hydroxylphenyl)-2H-benzotriazole, (2-2H-benzotriazole-2-yl)-6-(straight chain and branched dodecyl)-4-methylphenol, 2-hydroxy-4-benzyloxybenzophenone and 2,4-benzyloxybenzophenone; and also Tinuvins, such as Tinuvin 109, Tinuvin 171, Tinuvin 234, Tinuvin 326, Tinuvin 327 and Tinuvin 328, which are commercial products of Ciba Speciality Chemicals Corp., and can be used preferably. Among them, Tinuvin 109 and Tinuvin 171 are ultraviolet absorbers being a liquid state under a temperature of 20° C., and can be used still more preferably.

The cellulose ester film according to this invention preferably contains two types of ultraviolet absorbents or more.

The used amount of an ultraviolet absorbent is not uniform depending on a type and a used condition of an ultraviolet absorbent, however, in the case of the dry layer thickness of cellulose ester film being 30 to 200 μm, it is preferably 0.5 to 4.0 weight % and more preferably 0.6 to 2.0 weight %, to a cellulose ester film.

Here, in the producing method of the cellulose ester film of the present invention, an ultraviolet absorber may be added into a main dope in a cellulose ester resin dissolving process separately from a fine particles dispersion liquid. In this case, it is desirable that the ultraviolet absorber is added in a form of a additive liquid. Here, the additive liquid containing the ultraviolet absorber is a liquid containing the above ultraviolet absorber and added into a main dope, preferably contains the ultraviolet absorber by 1 to 30% by weight, more preferably by 5 to 20% by weight, still more preferably by 10 to 15% by weight. The smaller the content of the ultraviolet absorber is, excellent the solubility of the cellulose ester is. The larger the content of the ultraviolet absorber is, the smaller the additive amount is, and the easier the addition becomes. Therefore, the above range is preferable.

If the ultraviolet absorber additive liquid contains cellulose ester in addition to the ultraviolet absorber, it is preferable in terms of adjusting the viscosity of the additive liquid. The cellulose ester can use the same one as the main dope. Further, a recycled material may be sued as same as the main dope.

Moreover, in the method of the present invention, a plasticizer, an antioxidant, etc. are preferably added in a cellulose ester resin dope.

Plasticizers preferably usable in the present invention is not limited specifically, and examples of plasticizers include a phosphate type plasticizer such as triphenyl phosphate (TPP), biphenyl diphenyl phosphate (BDP), tricresyl phosphate, cresylphenyl phosphate, octyldiphenyl phosphate, diphenylbiphenyl phosphate, trioctyl phosphate and tributyl phosphate; a phthalate type plasticizer such as diethyl phthalate, dimethoxyethyl phthalate, dimethyl phthalate, dioctyl phthalate, dibutyl phthalate, di-2-ethylhexyl phthalate, butylphthalylbutyl glycolate, ethylphthalylethyl glycolate (EPGE), methylphthalylethyl glycolate and butylphthalylbutyl glycolate.

Two or more kinds of these plasticizers may be used in combination according to necessity. By the containing of these plasticizers, since a film excellent in dimensional stability and water resistant can be obtained, it is specifically preferable.

In the present invention, a preferable additive amount of plasticizer suitable for making the water absorption or the moisture content within a specific range, is 12% by weight or less to cellulose ester. When two or more kinds of plasticizers are used together, the total amount of these plasticizers may be 12% by weight or less.

In the optical film of the present invention, additives exhibiting the same action as a plasticizer other than the above-mentioned plasticizer can be contained. As these additives, if an additive is a low molecule organic compound capable of plasticizing a cellulose ester film, the same effect as a plasticizer can be acquired by the additive. In comparison with a plasticizer, these additives are not added for the purpose of directly plasticizing a cellulose ester film. However, these additives exhibit the similar action according to the added amount.

The cellulose ester film of the present invention may contain a compound composed of a multivalent alcohol ester of aliphatic polyhydric alcohol and one or more kinds of monocarboxylic acid. The content of the multivalent alcohol ester to cellulose ester is 4.5 to 12.5% by weight, preferably 6 to 12% by weight, still more preferably 7 to 11% by weight.

In the cellulose ester film of the present invention, the above-mentioned monocarboxylic acid is preferably a compound which includes an aromatic ring or a cycloalkyl ring in its molecule.

In the cellulose ester film of the present invention, the aliphatic polyhydric alcohol is divalent to 20-valent.

In this way, by the using of the multivalent alcohol ester, the added amount of conventional plasticizers can be reduced.

Next, the aliphatic multivalent alcohol ester usable in the present invention will be explained. The aliphatic multivalent alcohol ester is an ester of an aliphatic polyhydric alcohol of divalent or more and one or more kinds of monocarboxylic acid.

(Aliphatic Polyhydric Alcohol)

The aliphatic polyhydric alcohol (polyalcohol) usable for the present invention is an alcohol of divalent or more and represented by the following Formula [2].

R₁—(OH)ₙ Formula [2]

Wherein: R₁ represents an aliphatic organic group having a valence of n, n represents a positive integer of 2 or more, and OH group represents an alcoholic and/or phenolic hydroxyl group.

Here, examples of n-valent aliphatic organic group include alkylene groups (for example, a methylene group, ethylene, a trimethylene group, a tetramethylene group, etc.); alkenylene groups (for example, ethenylene group etc.); alkynylene groups (for example, ethynylene group etc.); cyclo alkylene groups (for example, 1,4-cyclohexanediyl group etc.); and alkanetriyl groups (for example, 1,2,3-propanetriyl group etc.). The n-valent aliphatic organic group includes one having substituents (for example, a hydroxy group, an alkyl group, a halogen atom, etc.).

n is preferably 2 to 20. Examples of preferable polyalcohol include adonitol, arabitol, ethylene glycol, diethylene glycol, triethylene glycol, tetraethylene glycol, 1,2-propanediol, 1,3-propanediol, dipropylene glycol, tripropylene glycol, 1,2-butanediol, 1,3-butanediol, 1,4-butanediol, dibutylene glycol, 1,2,4-butanetriol, 1,5-pentanediol, 1,6-hexanediol, hexanetriol, galactitol, mannitol, 3-methylpentane-1,3,5-triol, pinacol, sorbitol, trimethylolpropane, trimethylolethane and xylitol. In particular, triethylene glycol, tetraethylene glycol, dipropylene glycol, tripropylene glycol, sorbitol, trimethylolpropane and xylitol. Especially, preferable are triethylene glycol, tetraethylene glycol, dipropylene glycol, a tripropylene glycol, sorbitol, trimethylolpropane, and xylitol.

(Monocarboxylic Acid)

In the present invention, a mono carboxylic acid in the polyalcohol ester is not specifically limited, and well known compounds such as aliphatic monocarboxylic acid, alicyclic monocarboxylic acid and aromatic monocarboxylic acid may be used. Alicyclic monocarboxylic acid or aromatic monocarboxylic acid is preferably used in terms of improving moisture permeability and retaining ability.

Examples of preferable monocarboxylic acids are listed below. However, the present invention is not limited thereto.

For aliphatic monocarboxylic acids, normal or branched fatty acids having from 1 to 32 carbon atoms are preferably used. The number of carbon atoms is more preferably from 1 to 20 and still more preferably from 1 to 10. The containing of an acetic acid will help improve the mutual solubility, therefore a mixture of an acetic acid and other monocarboxylic acids is also preferably used.

Examples of preferable aliphatic mono carboxylic acids include unsaturated fatty acids such as: acetic acid, propionic acid, butyric acid, valeric acid, caproic acid, enanthic acid, caprylic acid, pelargonic acid, capric acid, 2-ethyl-hexanoic acid, undecylic acid, lauric acid, tridecylic acid, myristic acid, pentadecylic acid, palmitic acid, heptadecanoic acid, stearic acid, nonadecane acid, arachidic acid, behenic acid, lignoceric acid, cerotinic acid, heptacosanoic acid, montanic acid, melissic acid, lacceric acid, as well as unsaturated fatty acids such as: undecylic acid, oleic acid, sorbic acid, linoleic acid, linolenic acid and arachidonic acid. These may have a substituent further.

Examples of preferable alicyclic monocarboxylic acids include cyclopentanecarboxylic acid, cyclohexanecarboxylic acid, cyclooctanecarboxylic acid, and derivatives thereof.

Examples of preferable aromatic monocarboxylic acids include: benzoic acid and toluic acid, both of which have benzene ring in which alkyl groups are introduced, biphenylcarboxylic acid, naphthalenecarboxylic and tetralincarboxylic acid having 2 or more benzene rings, and derivatives thereof. Among them, benzoic acid is specifically preferred.

### (Polyalcohol Ester)

The molecular weight of the polyalcohol ester is not limited specifically. However, the molecular weight is preferably from 300 to 1,500 and more preferably from 350 to 750. A larger molecular weight is preferable in terms of retaining ability, while a smaller molecular weight is preferable in terms of moisture permeability, and mutual solubility with cellulose ester.

In the present invention, carboxylic acid in a polyalcohol ester may be used with one kind or as a mixture of two or more kinds. Hydroxyl groups in a polyalcohol may be completely esterified or only partially esterified so as to remain unsubstituted hydroxyl groups. Preferably, it has three or more of aromatic rings or cycloalkyl rings in its molecule.

Examples of polyalcohol esters usable in the present invention are shown below:

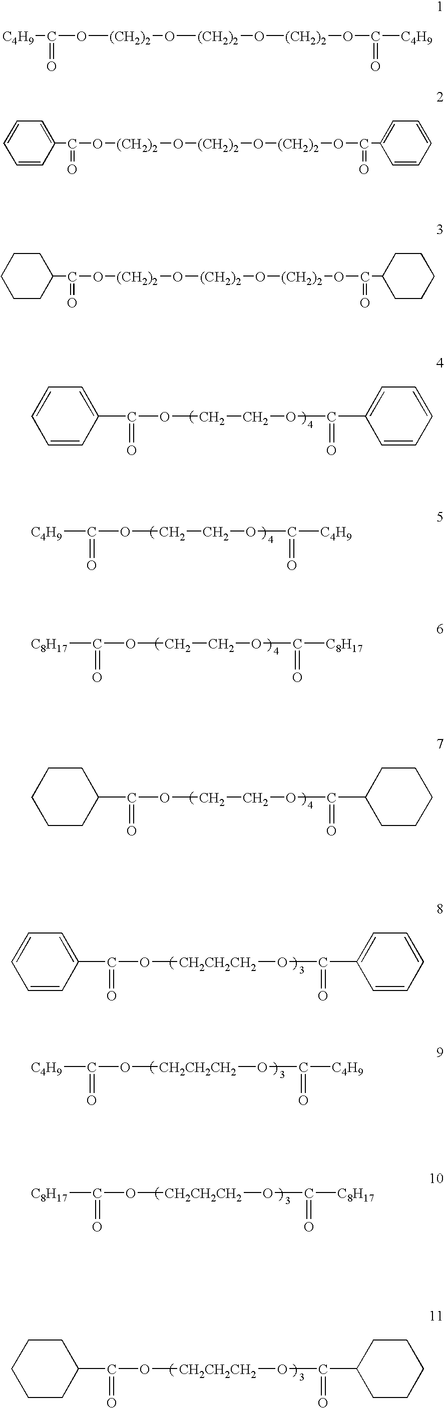

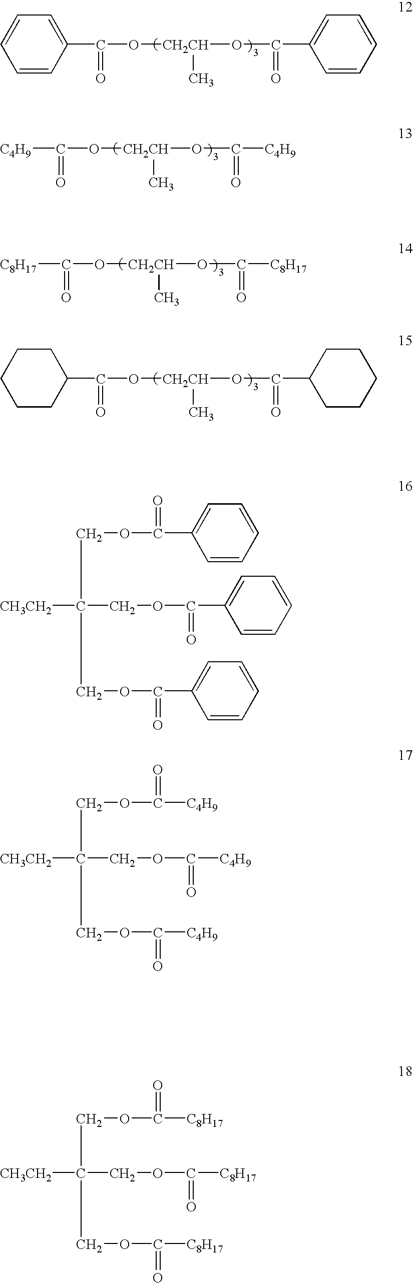

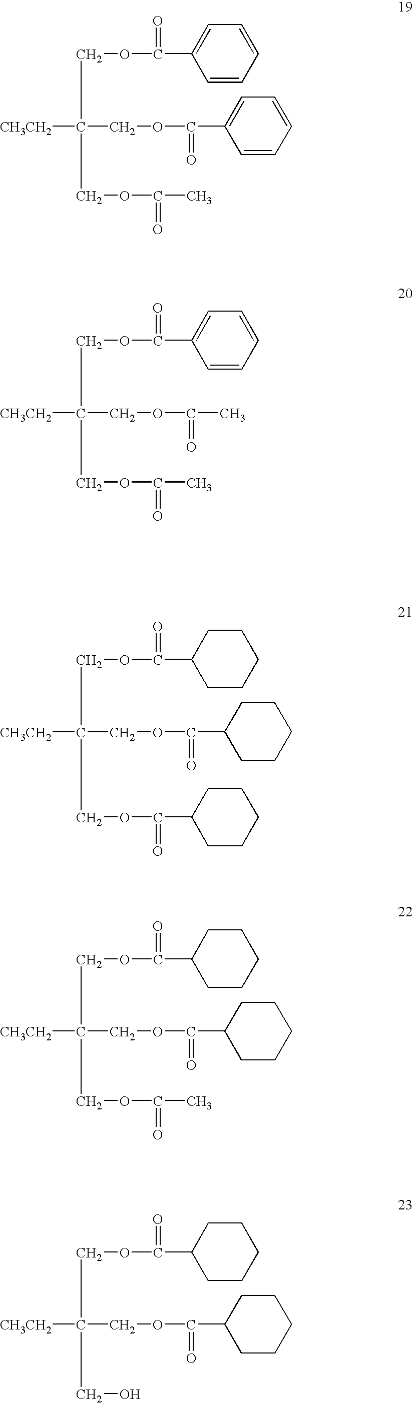

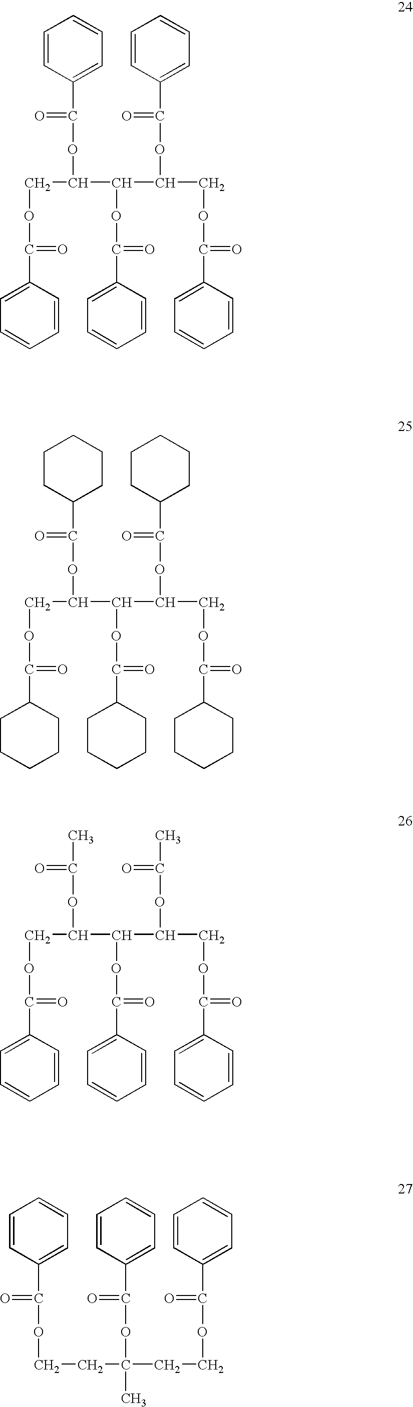

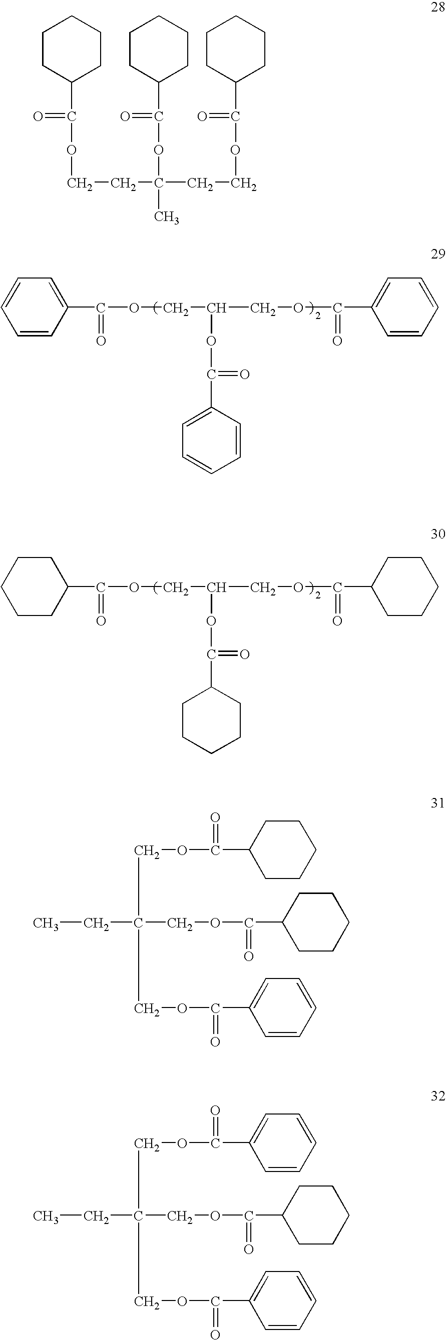

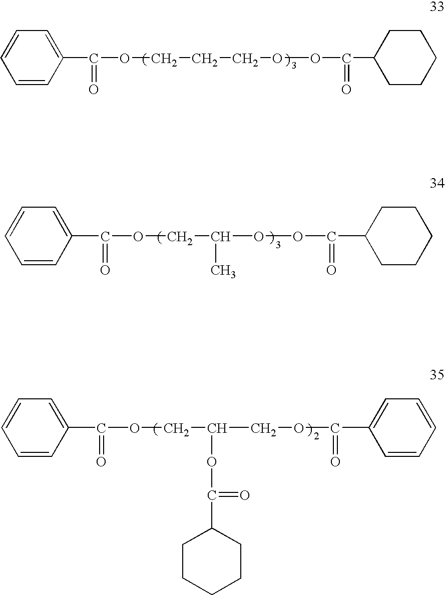

Among the above polyalcohol esters, preferable are mixed ester of trimethylolpropane tribenzoate (TMPTB), Trimethylolpropane triacetate, trimethylolpropane tripropionate, dipropylene glycol dibenzoate, tripropylene glycol dibenzoate, 1,3-dibutyleneglycol dibenzoate, tetraethylene glycol dibenzoate, trimethylolpropane and acetic acid and benzoic acid; esters of trimethylolpropane and cyclohexanecarboxylic acid; mixed ester of trimethylolpropane and acetic acid and cyclohexanecarboxylic acid; ester of 3-methylpentane-1,3,5-triol and cyclohexanecarboxylic acid; ester of 3-methylpentane-1,3,5-triol and benzoic acid; ester of xylitol and benzoic acid; and ester of xylitol and cyclohexanecarboxylic acid.

Herein, the used amount of the multivalent alcohol ester is desirably 4.5 to 12.5% by weight to cellulose ester, more desirably 6 to 12% by weight, still more desirably 7 to 11% by weight.

The cellulose ester film of the present invention contains additives such as a plasticizer and an ultraviolet absorber other than cellulose ester and a solvent and the compound comprised of the above-mentioned multivalent alcohol ester.

The additives such as the compound comprised of the multivalent alcohol ester, a plasticizer and an ultraviolet absorber is mixed beforehand with a solvent, dissolved and dispersed, thereafter added into a solvent before the dissolving of cellulose ester or into a dope after the dissolving of cellulose ester.

The above multivalent alcohol ester has a function of a plasticizer and such a multivalent alcohol ester can be used together with conventional plasticizer. In such a case, although the multivalent alcohol ester can used in a range of 4.5 to 12.5% by weight to cellulose ester as mentioned above, the total amount of the multivalent alcohol ester and a plasticizer is preferably 12.5% by weight or less to cellulose ester. Further, in this case, the used amount of a plasticizer is preferably 8.0% by weight or less to cellulose ester. Especially, it is desirable that the used amount of the multivalent alcohol ester is 7% by weight or more to cellulose ester, and, further, the used amount of the plasticizer used is preferably 5.5% by weight or less to cellulose ester. Because, by the use of the multivalent alcohol ester, the used amount of conventional plasticizer can be reduced.

The producing method of cellulose ester film as a desirable embodiment of the present invention will be explained.

The desirable film producing process being used for the producing method of cellulose ester film of the present invention comprises a dissolving process, a casting process, a solvent evaporating process, a peeling process, a drying process, and a winding-up process which are shown below. Hereafter, each process will be explained.

The dissolving process is a process of dissolving flakes of cellulose ester into an organic solvent mainly composed of the above-mentioned good solvent in a dissolving tank while stirring the flake and forming a dope.

The concentration of solid components in a dope is preferably adjusted to be 15% by weight or more, especially preferable to be 18% to 35% by mass.

If the concentration of the solid components in a dope is too high, the viscosity of the dope becomes too high, thereby causing sharkskin so that the flatness of a film may be deteriorated. Accordingly, 35% by weight or less is desirable.

The viscosity of a dope is preferably adjusted to be within a range of 10 to 50 Pa·s.

As a dissolving method, there are various dissolving methods, such as a method of performing under an ordinary pressure, a method of performing under a temperature below the boiling point of a desirable organic solvent (namely, good solvent), a method of performing under an added pressure and a temperature above the boiling point of the above-mentioned good solvent, a method of performing with a cooling dissolving method, and a method of performing with a high pressure, and so on. As a dissolving method by adding a pressure not to cause boiling under a temperature above the boiling point of a good solvent, by adding a pressure to 0.11 to 1.50 MPa under a temperature of 40.4 to 120° C., it may be possible to dissolve in a short time by suppressing foaming.

In the method of the present invention, additives, such as an ultraviolet absorber, a plasticizer, and an antioxidant may be added together with cellulose ester resin and a solvent during the time of preparing cellulose ester resin solution, or may be added during the preparing of the solution or after the preparing.

By the use of the thus obtained dope, a cellulose ester film can be obtained through the below-mentioned casting process.

The cellulose ester resin film having few foreign matters can be obtained by the filtering of the dope composition including cellulose ester resin dissolved in a solvent by the following filter paper, though the means is not specifically limited. In this case, it is preferable that the dope composition is filtered with a filter paper having a water filtering time of 20 seconds or more while being applied with a filtering pressure of 1.6 MPa or less and then a film is formed by the use of the filtered dope composition. It is more preferable to filter the dope composition with a filter paper having the water filtering time of 30 seconds or more and the filter pressure of 1.2 MPa or less, and further preferable with a filter having the water filtering time of 40 seconds or more and the filtering pressure of 0.98 MPa or less. Further, it may be preferable to use filters by the superimposing of two sheets or more. Further, the filtering pressure can be controlled by the proper selection of the filtering flow rate and the filtering area.

In the present invention, it is preferable that the cellulose ester resin solution (dope) containing the silicon dioxide fine particles added in the cellulose ester resin dissolving process is made to pass through a filter paper having a colleting particle size of 2.5 μm, a film is formed by the use of the solution obtained by the filtering, and the collecting ratio of secondary fine particles including the silicon dioxide fine particles by the filter paper is 5% or less. Because, by the use of a specific filter paper and by the specification of the collecting ratio of secondary fine particles in the filtering process for the dope containing the silicon dioxide fine particles added in the cellulose ester resin dissolving process, the number of foreign matters can be greatly reduced and a cellulose ester film excellent in optical characteristics can be produced.

Next, a cellulose ester film producing apparatus to conduct the cellulose ester film producing method of the present invention will be explained with reference to drawings.

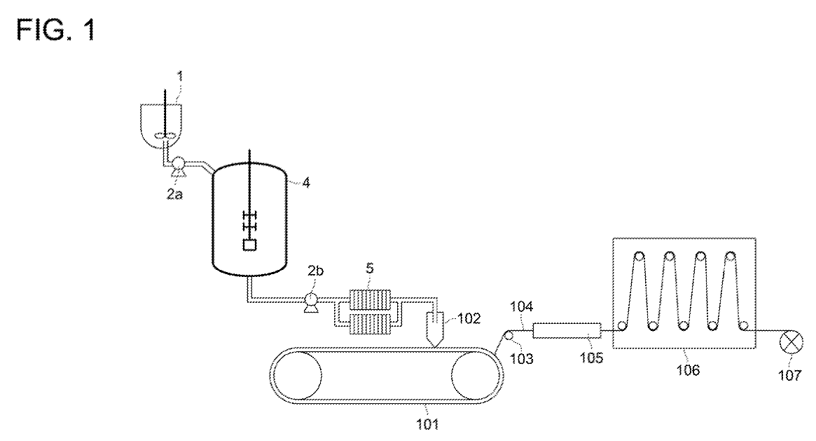

FIG. 1 shows an outline of the cellulose ester film producing apparatus to conduct the cellulose ester film producing method of the present invention.

In the present invention, the cellulose ester film producing method produces a film by the use of a cellulose ester resin solution containing fine particles with a solution casting film forming method. The fine particles are added in a process of dissolving cellulose ester resin into a main solvent at a temperature of a boiling point of the main solvent or less under atmospheric pressure, after the adding, the fine particles are mixed at a temperature of the boiling point of the main solvent or more.

With reference to FIG. 1, in the present invention, firstly, a fine particle dispersion liquid to be added into a dope is prepared in a preparation tank 1 of a fine particle dispersion liquid, and this fine particle dispersion liquid is introduced to a main dope dissolving tank 4 by the work of a liquid feeding pump 2a and added into a cellulose ester resin solution (dope). In this case, fine particles are added at a temperature below the boiling point of a main solvent under atmospheric pressure. Moreover, it is desirable to add the fine particles to be added in the cellulose ester system resin dissolving process during the adding of cellulose ester system resin into the dissolving tank or after the adding and before complete dissolution of the cellulose ester resin in the dissolving tank. The cellulose ester resin solution (dope) contains a plasticizer, an antioxidant and the like in addition to the fine particles.

Then, the fine particle containing dope is introduced to a filter device 5 by the work of a liquid feeding pump 2b, and is filtered. In the filter device 5, the fine particle containing dope is filtered by a filtering medium whose 90% collecting particle size is 10 times to 100 times of the average particle size of the fine particles.

After the filtering, the fine particle containing dope is introduced into a casting die 102 so that a cellulose ester film is produced by a solution casting film forming method.

Here, it may be preferable that the filtered fine particle containing dope is stored once in a dope stock tank (illustration is omitted). Moreover, as mentioned above, in the method of the present invention, it is desirable to make the fine particle dispersion liquid contain an ultraviolet absorber. However, the present invention is not limited to this. For example, an ultraviolet absorber additive liquid is prepared beforehand in an additive liquid dissolving tank which is not illustrated, and while the above-mentioned fine particle containing dope is introduced into a static mixer (illustration is omitted), the ultraviolet absorber additive liquid is introduced into the inlet side of the static mixer such that the ultraviolet absorber additive is added into the fine particle containing dope by in-line. After the adding of the ultraviolet absorber additive liquid, the fine particle containing dope is introduced into a casting die 102.

In the present invention, the dope produced as mentioned above is cast by the casting die 102 on a support 101 composed of, for example, an endless belt made from stainless steel.

A preferable example of the casting die 102 is a pressure-applicable die in which the shape of a slit on the mouthpiece portion of the die is adjustable and a film thickness is easily made uniform.

As the support 101, employed is a support 101 in which a rotatable endless belt made from a stainless steel or a rotatable drum made from a stainless steel is finished to a mirror faced. The casting can be carried out at a support temperature within a general range of from 0° C. to less than the boiling point of a solvent. However, the casting on the support 101 at a temperature of from 5 to 30° C. is preferable because the limitation time for peeling by gelling the dope can be shortened, and the casting at a temperature of from 5 to 15. ° C. is more preferable. Here, the peeling limitation time is the time during which the cast dope exists on the support 101 at the limiting casting rate capable of continuously obtaining a film being good in transparency and flatness. A shorter peeling limit time is preferable, because high production efficiency can be obtained.

In the process of drying on the support 101, when the time from the casting to the peeling by a peeling roller 103 is 100%, it is preferable that after the cast dope is once gelled, the temperature of the dope is made to a temperature of from 40 to 70° C. within 30% from the casting, whereby the evaporation of the solvent can be advanced, the dope can be peeled earlier in accordance with the advanced evaporation, and the peeling strength increases. It is more preferable that the temperature of the dope is made to a temperature of from 55 to 70° C. within 30%. Thereafter, it is preferable to maintain the temperature for 20% or more, and it is more preferable to maintain the temperature for 40%.

In the process of drying on the support 101, it is preferable to peel off the web 104 from the support 101 by a peeling roller 103 at a state of that the remaining amount of the solvent is within the range of from 60 to 150%, more preferably from 80 to 120%, because the peeling strength from the support 101 becomes small. The temperature of the dope at the time of peeling off is preferably from 0 to 30° C., and more preferably from 5 to 20° C., because the strength of the base at the time of peeling can be increased and as a result, the base fracture at the time of peeling off can be prevented.

In the production of cellulose ester film by the solution casting method, the amount of remaining solvent is expressed by the following formula.

Remaining solvent amount (% by weight)={(M−N)/N}×100

Here, M is the weight of the web (film) at an optional time point and N is the weight of the film after the film with the weight of M is subjected to a heat treatment at 115° C. for 1 hour.

In the film drying process, the film peeled off from the support 101 by the peeling roller 103 is further dried in such a way that the remaining solvent amount is reduced to 3% by weight or less, preferably 1% by weight or less, and further preferably 0.5% by weight or less, for obtaining the film having high dimensional stability.

After the peeling-off, the web 104 is dried by the use of a tenter apparatus 23 to convey the web 104 while holding the both edged of the web 104 by clips or pins and/or a drying apparatus 106 to convey the web by passing the web 104 alternatively through conveying rollers arranged plural in the drying apparatus. For film as parts of a liquid crystal display, the drying while holding the width of the film by the tenter system is preferable, because the dimensional stability can be enhanced. Particularly, it is preferable to hold the width of the film at the point where the remaining solvent amount is high just after the peeling from the support 101, because the dimensional stability improving effect can exhibit.

Especially, the web 104 tends to shrink in the width direction by the evaporation of solvent in the drying process right after being peeled from the support 101. The shrinking becomes greater, as the film is dried at higher temperature. It is preferable to dry the film while suppressing the shrinking as far as possible, because the flatness of the finished film can be made well. From such the viewpoint, preferable is the tenter method, namely the method disclosed in JP-A No. 62-46625 in which the whole or a part of the drying process is carried out while holding at the both edges of the web 104 by the clips.

Means for drying the film is not specifically limited and usually hot air, infrared rays, a heating roller and microwave are applied. The hot air is preferred from the viewpoint of simplicity. It is preferable that the drying temperature is gradually raised by three to five steps within the range of from 40 to 150° C., and the range of from 80 to 140° C. is more preferable for improving the dimensionally stability.

The processes of from the casting to the drying may be carried out under an atmosphere of air or inactive gas such as nitrogen. Needless to say, the drying should be carried out with consideration for the explosion limit concentration of the solvent gas in the atmosphere.

After the remaining solvent amount in the dried film 26 becomes 2% by weight or less, the film is wound up as a cellulose ester resin film by a winding device 107 into a rolled state. The film having good dimensional stability can be obtained by making the remaining solvent amount to 0.4% by weight or less.

The winding device 107 may be an usually-used one, and the film can be wound up by winding methods such as a constant tension method, a constant torque method, a taper tension method and a programmed tension method for maintaining constant inner stress.

In order to stabilize the wound-up ability, it may be preferable to apply a knurling treatment to provide concavo-convex to both ends in the width direction of the cellulose ester resin film so as to make the height of the both ends high.

Assuming that the ration of the knurling height (a: μm) to the film thickness (d: μm) is X (X(%)=(a/d)×100), when X is in a range of 0 to 25% (X=0 to 25), the wound-up ability can be preferably stabilized.

Preferably, X is in a range of 0 to 15%, more preferably in a range of 0 to 10%. If the knurling height ratio is larger than the above range, the deformation of a wound-up shape may tends to occur, on the other hand, If the ratio is small, the wound-up ability deteriorates.

In the present invention, the thickness of the cellulose ester resin film is usually from 20 to 200 μm. However, with consideration for the request to make a polarizing plate used in a liquid crystal display device (LCD) to be more thinner and lighter, the thickness is preferably from 20 to 65 μm, more preferably from 30 to 60 μm, and further preferably from 25 to 50 μm. When the film is thinner than the above range, since the toughness of the film is lowered, troubles due to occurrence of wrinkles in a polarization plate producing process tends to occur, and when the thickness is thicker than the above range, contribution on the thickness reduction of the LCD becomes small.

In the cellulose ester film produced by the method of the present invention, the variation coefficient of fine particles (average particle diameter/standard deviation) in a cross section of a cut-out piece of the cellulose ester film is 50% or less, preferably 30% or less in the particle diameter measurement of fine particles by the use of a transmission electron microscope. Thus, by specifying the variation coefficient (average particle diameter/standard deviation) of fine particles contained in the cellulose ester film, the distribution of the fine particles contained in the cellulose ester film is very good, there is no occurrence of the generation of foreign matters, and the optical characteristic of the cellulose ester film becomes excellent.

Further, in the cellulose ester film of the present invention, in the particle diameter measurement of fine particles by the use of a transmission electron microscope in a cross section of a cut-out piece of the cellulose ester film, the particle diameter measurement is a measurement for secondary fine particles, a primary particle diameter is 20 nm or less and a secondary particle diameter is 150 nm to 250 nm. In this way, by specifying the primary particle diameter and the secondary particle diameter to a specific one, there is no occurrence of the generation of foreign matters, and the cellulose ester film is excellent in the optical characteristic.

Further, the haze of the cellulose ester film is 0 to 0.5% and the dynamic friction coefficient of a back side surface is 0.5 to 0.7. Like this, by specifying the haze of the cellulose ester film to a specific one, the transparency of the film is excellent, and by specifying the dynamic friction coefficient of the back side surface to a specific one, the sliding ability becomes good and films hardly adhere to each other, therefore, the handling ability at the time of processing the back surface of these cellulose ester films can be improved and the winding ability can be stabilized.

Since the cellulose ester film of the present invention has good moisture permeability, dimensional stability, etc., the cellulose ester film is desirably used for a member for a liquid crystal display, specifically for a polarizing plate protective film. Especially, for a polarizing plate protective film having severe request for moisture vapor transmission and dimensional stability, the cellulose ester film of the present invention is preferably used.

By the way, a polarizing plate can be produced by general methods. For example, there is a method in which an optical film or a cellulose ester film is subjected to an alkali saponification treatment, and the film is pasted with a full saponification type Polyvinyl alcohol aqueous solution onto both sides of a polarization film produced in such a way that a polyvinyl alcohol film is immersed in an iodine solution and stretched. The alkali saponification treatment is a process of dipping a cellulose ester film into strong alkali liquid at high temperature in order to improve the wetability of water base adhesive and to enhance an adhesive property.

Onto the cellulose ester film of the present invention, it is possible to provide various functional layers, such as a hard coat layer, an antiglare layer antireflection layer, an antifouling layer, an antistatic layer, a conductive layer, an optical anisotropy layer, a liquid crystal layer, an orientation layer, an adhesion layer, a glue line, and an under-coated layer. These functional layers may provided by methods, such as coating or vacuum evaporation, spattering, plasma CVD, and atmospheric pressure plasma treatment.

The thus obtained polarizing plate is provided at one side or both sides of a liquid crystal cell, and a liquid crystal display is obtained by the use of this liquid crystal cell.

By the use of the polarizing plate protective film composed of the cellulose ester film of the present invention, it is possible to provide a polarizing plate excellent in durability and dimensional stability and optical isotropy in addition to its thinner thickness.

Furthermore, in a liquid crystal display employing a polarizing plate protective film or a retardation film composed of the cellulose ester film of the present invention, it is possible to maintain the stable display performance over a long period of time.

The cellulose ester film of the present invention can be used also as a base material of an antireflections film or an optical compensation film.

### EXAMPLE

Hereafter, examples of the present invention are described. However, the present invention is not limited to these examples.

### Example 1

In manufacture of a cellulose triacetate film, firstly, fine particle dispersion liquid was produced as follows by the method of the present invention.

### (Production of Fine Particle Dispersion Liquid)

| | |
|---|---|
| Ethanol | 27 parts by weight |
| Silicon dioxide fine particles | 3 parts by weight |
| (Trade name: Aerosil 200V, | |
| Primary particle size: 12 nm; | |
| produced by Japan Aerosil Co., Ltd.) | |

The above-mentioned ingredients were put into a container and are mixed, and the mixture was stirred at a rotation speed of 500 rpm for 30 minutes, after that, the resultant mixture was dispersed with a pressure of 24.5 MPa by a Manthon Gaulin type hyperbaric pressure dispersion machine (fine particle dispersion liquid preparing tank) 1 (refer to FIG. 1), whereby the dispersion liquid was produced.

### (Dope Composition)

| | |
|---|---|
| Cellulose triacetate (acetylation degree: 61.0%) | 100 parts by weight |
| Ethylphthalyl ethyl glycolate (plasticizer A) | 2 parts by weight |
| Triphenyl phosphate (plasticizer B) | 8 parts by weight |
| Methylene chloride | 475 parts by weight |
| Ethanol | 50 parts by weight |

The materials of the above-mentioned dope compositions were put into a dissolving tank 4, and cellulose triacetate (TAC) was dissolved while the materials were being stirred. And, in this Example 1, the fine particle dispersion liquid was added during the adding of the cellulose triacetate into the dissolving tank 4. After the adding, the dispersion liquid was dissolved and mixed at a temperature of the boiling point of the main solvent or more, and preferably, (the boiling point+50° C.) or less. In this Example 1, the cellulose triacetate was dissolved and mixed at a temperature of 80° C. higher by 40° C. than the boiling point (40° C.) of methylene chloride being a main solvent. Further, the dissolving and mixing of the fine particle dispersion liquid in the cellulose triacetate dissolving process was conducted for 120 minutes.

### (Production of Ultraviolet Absorber Additive Liquid)

Next, a liquefied ultraviolet absorber and the same resin as the cellulose triacetate film was dissolved and mixed, whereby the ultraviolet absorber additive liquid was produced.

| | |
|---|---|
| Cellulose triacetate | 12 parts by weight |
| 2-(2′-hydroxy-3′,5′-di-t-butylphenyl) benzotriazol | 26 parts by weight |
| (ultraviolet absorber) | |
| Methylene chloride | 268 parts by weight |

The above-mentioned ingredients were put into a container, and dissolved and mixed, whereby the ultraviolet absorber addition liquid was produced. Subsequently, the ultraviolet absorber additive liquid was added by in-line into the cellulose triacetate solution (dope) containing the silicon dioxide fine particles added in the above-mentioned cellulose triacetate dissolving. In this adding by in-line addition, the ultraviolet absorber additive liquid was mixed sufficiently by an in-line mixer (a static type in-pipe mixer Hi-Mixer, SWJ produced by Toray Industries, Inc.) which is not illustrated.

In the thus obtained dope, the additive amount of fine particles to the cellulose triacetate was 0.1% by weight.

Furthermore, the cellulose triacetate solution (dope) containing the above-mentioned silicon dioxide fine particles and ultraviolet absorber was made to pass through a filter paper having a collecting particle size of 2.5 μm and the thus obtained filtered solution was used for a film formation. At this time, the collecting rate of the secondary fine particles containing the silicon dioxide fine particles by the above-mentioned filter paper was made 1.0%.

Subsequently, the above-mentioned produced dope for casting with a dope temperature of 35° C. was cast uniformly on a support 10 composed of an endless belt made of stainless steel with a temperature of 30° C. by the use of a belt casting apparatus shown in FIG. 1. After the cast dope was dried to a range capable of being peeled, the dope was peeled from the support 101. At this time, the remaining solvent amount of the dope was 2.5% by weight.

The solvent was evaporated from the peeled web of cellulose acetate at 35° C. and the web was slit into the width of 1650 mm. Thereafter, the web was dried at a drying temperature of 135° C. while being stretched to 1.07 times in the width direction by a tentar. At the time of starting stretching by the tentar, the remaining solvent amount was 10% be weight. After that, the drying process was completed while the web was being conveyed in the drying zones of 110° C. and 120° C. by many rollers. The film of the dried web was slit into a width of 1430 m and applied with a knurling process with a width of 10 mm at each of both ends of the film and a height of 5 μm. And then, the film was wound up around a core having a inside diameter of 6 inch with the initial tension of 220 N/m and a final stress 110 N/m, whereby the cellulose triacetate film was obtained. The remaining solvent amount of the cellulose triacetate was 0.004% by weight, the film thickness was 40 μm, and the number of wound-up was 2600 m.

With regard to samples of the cellulose triacetate film produced in this Example 1, the kind of the used fine particles, the additive amount (% by weight) of the fine particles to the cellulose triacetate, the adding timing of the fine particle dispersion liquid, the dissolving and mixing time period (minute) after the adding of the fine particle dispersion liquid, the dissolving and mixing temperature (° C.) at the time of adding the fine particle dispersion liquid, and the method of adding the ultraviolet absorber addition liquid (UV liquid) are shown in the following Table 1.

### Example 2

With the same way as that in the case of the above Example 1, cellulose triacetate film was produced by the method of the present invention. Into the fine particle dispersion liquid in Example 1, the same resin as the cellulose triacetate film was dissolved and mixed, and further, a liquefied ultraviolet absorber was dissolved and mixed, whereby the additive liquid was produced.

### (Production of Additive Liquid)

| | |
|---|---|
| Fine particle dispersion liquid | 22 parts by weight |
| Cellulose triacetate | 12 parts by weight |
| 2-(2′-hydroxy-3′,5′-di-t-butylphenyl) benzotriazol | 26 parts by weight |
| (ultraviolet absorber) | |
| Methylene chloride | 290 parts by weight |

### (Dope Composition)

| | |
|---|---|
| Cellulose triacetate (acetylation degree: 61.0%) | 100 parts by weight |
| Ethylphthalyl ethyl glycolate (plasticizer A) | 2 parts by weight |
| Triphenyl phosphate (plasticizer B) | 8 parts by weight |
| Methylene chloride | 475 parts by weight |
| Ethanol | 50 parts by weight |

The materials of the above-mentioned dope compositions were put into a dissolving tank 4, and cellulose triacetate (TAC) was dissolved while the materials were being agitated. And, in this Example 2, the additive liquid containing the fine particles and the ultraviolet absorber was added during the adding of the cellulose triacetate into the dissolving tank 4. After the adding, as same as Example 1, the cellulose triacetate was dissolved and mixed at a temperature of 80° C. higher by 40° C. than the boiling point (40° C.) of methylene chloride being a main solvent. Further, the dissolving and mixing of the fine particle dispersion liquid in the cellulose triacetate dissolving process was conducted for 120 minutes.

In the thus obtained dope, the additive amount of fine particles to the cellulose triacetate was 0.5% by weight.

The cellulose triacetate solution (dope) containing the silicon dioxide fine particles added in the cellulose triacetate dissolving process was made to pass through a filter paper having a collecting particle size of 2.5 μm and the thus obtained filtered solution was used for a film formation. At this time, the collecting rate of the secondary fine particles containing the silicon dioxide fine particles by the above-mentioned filter paper was made 5.0%.

Subsequently, the above-mentioned produced dope for casting was cast as the same way as that in Example 1. Then, the cellulose triacetate film with a film thickness of 40 μm was produce by the solution casting film forming method.

With regard to samples of the cellulose triacetate film produced in this Example 2, the kind of the used fine particles, the additive amount (% by weight) of the fine particles to the cellulose triacetate, the adding timing of the fine particle dispersion liquid, the dissolving and mixing time period (minute) after the adding of the fine particle dispersion liquid, the dissolving and mixing temperature (° C.) at the time of adding the fine particle dispersion liquid, and the method of adding the ultraviolet absorber addition liquid (UV liquid) are shown in the following Table 1.

### Examples 3 to 12

With the same way as that in the case of the above Example 2, cellulose triacetate film was produced. Except that the kind of the used fine particles, the additive amount (% by weight) of the fine particles to the cellulose triacetate, the adding timing of the fine particle dispersion liquid, the dissolving and mixing time period (minute) after the adding of the fine particle dispersion liquid, the dissolving and mixing temperature (° C.) at the time of adding the fine particle dispersion liquid, and the method of adding the ultraviolet absorber addition liquid (UV liquid) were changed as shown in Table 1, the cellulose triacetate films with a film thickness of 40 μm were produced as the same way as that in Example 2.

With regard to samples of the cellulose triacetate film produced in these Examples 3 to 12, the kind of the used fine particles, the additive amount (% by weight) of the fine particles to the cellulose triacetate, the adding timing of the fine particle dispersion liquid, the dissolving and mixing time period (minute) after the adding of the fine particle dispersion liquid, the dissolving and mixing temperature (° C.) at the time of adding the fine particle dispersion liquid, and the method of adding the ultraviolet absorber addition liquid (UV liquid) are shown in the following Table 1.

### Comparative Example 1

For comparison, in this Comparative example 1, silicon dioxide fine particles were dispersed in a solvent with a conventional method, this dispersion was added in a solution containing an ultraviolet absorber so as to produce a fine particle additive liquid, and this liquid was added a main dope of cellulose triacetate by in-line.

Subsequently, from the thus produced dope for casting, hereafter, a cellulose triacetate film with a thickness of 40 μm was produced by the solution cast film forming method in the same way as that in Example 1.

### Comparative Example 2

For comparison, a cellulose triacetate film was produced with the same way as that in the above Example 2. However, in this Comparative example 2, an addition liquid containing fine particles and an ultraviolet absorber was added during the adding of cellulose triacetate into a dissolving tank 4. After the adding, the cellulose triacetate was dissolved and mixed at a temperature of 25° C. lower by 15° C. than the boiling point (40° C.) of a main solvent of methylene chloride.

Subsequently, from the thus produced dope for casting, hereafter, a cellulose triacetate film with a thickness of 40 μm was produced by the solution cast film forming method in the same way as that in Example 1.

### Comparative Example 2

For comparison, a cellulose triacetate film was produced with the same way as that in the above Example 2. However, in this Comparative example 3, a fine particle dispersion liquid was added after a cellulose triacetate was dissolved and mixed in a dissolving tank 4. On the other hand, an ultraviolet absorber additive liquid containing an ultraviolet absorber was produced, and this liquid was added into a dope of cellulose triacetate containing fine particles by in-line.

Subsequently, from the thus produced dope for casting, hereafter, a cellulose triacetate film with a thickness of 40 μm was produced by the solution cast film forming method in the same way as that in Example 1.

With regard to samples of the cellulose triacetate film produced in these Comparative Examples 1 to 3, the following Table 1 shows the kind of the used fine particles, the additive amount (% by weight) of the fine particles to the cellulose triacetate, the adding timing of the fine particle dispersion liquid, the dissolving and mixing time period (minute) after the adding of the fine particle dispersion liquid, the dissolving and mixing temperature (° C.) at the time of adding the fine particle dispersion liquid, and the method of adding the ultraviolet absorber addition liquid (UV liquid).

For each sample of cellulose ester films produced in the above Examples 1 to 12 and Comparative examples 1 to 3, evaluation was conducted in terms of collecting ratio of secondary fine particles, average particle diameter (nm) of secondary grains of the obtained cellulose triacetate film, variation coefficient (average particle diameter/standard deviation) of fine particles in a film cross section, haze (t) of a film, dynamic friction coefficient of a film, and the obtained results are shown together in Table 1. The performance evaluation for each item was conducted as follows.

### (Evaluation Method)

### 1. Collecting Ratio of Secondary Fine Particles (Matting Agent)

A cellulose triacetate solution (dope) containing silicon dioxide fine particles added in the dissolving process of cellulose triacetate was made to pass through a filter paper having a collecting particle size of 2.5 μm, and a film was formed by the use of the thus filtered solution. Here, the collecting ratio of secondary fine particles containing silicon dioxide fine particles with the above filter paper was made to 1.0%.

### 2. Quantitative Determination of Secondary Fine Particles (Matting Agent (Quantity of Si))

A film at the last part of a roll of 2600 m wound-up was sampled, 0.5 g of the sample was melt with alkali and prepared into 50 ml aqueous solution, and the quantitative analysis of Si was conducted by ICP-AES (inductively-coupled plasma atomic emission spectroscopy apparatus). The used apparatus was SPS-4000 produced by SEIKO electronic industry.

### Particle Size of Secondary Fine Particles (Matting Agent (Si))

Particles were observed with a scanning type electron microscope (magnification of 3000 times), and the diameter of a circle circumscribing to particle was made as a particle size. Further, the sample place was changed, and the sizes of 100 particles were observed, and the average of the observed sizes was made as average particle size.

3. The variation coefficient (average particle diameter/standard deviation) of fine particles in a cross section of a cut-out piece of a cellulose triacetate film was calculated from a particle size measurement of fine particles by the use of a transmission type electron microscope.

4. Haze: It was measured in accordance with the method, specified in ASTM-D 1003-52.

5. Dynamic friction coefficient: The dynamic friction coefficient between the obverse surface and reverse surface of the film was measured as follows in accordance with JIS-K-7125 (1987). The film was cut out such that the obverse surface and reverse surface were brought in contact with each other, a weight of 200 g was place on the film, the weight was pulled in the horizontal direction on the condition of a sample shifting speed of 100 mm/minutes and a contact area of (80 mm×200 mm), an average load during the shifting of the weight was measured and the dynamic friction coefficient was obtained from the following formula.

Dynamic friction coefficient=F(gf)/the weight (gf) of the weight

TABLE 1

| | Fine particle dispersion liquid | | | | | | | | | | |
|---|---|---|---|---|---|---|---|---|---|---|---|
| | | Additive | Adding | | | | | | | | |
| | | amount | timing of | | | Adding | Secondary | Secondary | | | |
| | Kinds | of fine | fine | Dissolving | Dissolving | method | fine | fine | | | |
| | of | particles | particle | and mixing | and mixing | for | particle | particle | | | |
| | fine | (% by | dispersion | time | temperature | ultraviolet | collecting | average | | Haze | |
| | particles | weight) | liquid | (minutes) | (° C.) | absorber | ratio (%) | size (nm) | *3 | (%) | *4 |
| Example 1 | 200V | 0.1 | *1 | 120 | 80 | In-line | 1.0 | 200 | 50 | 0.1 | 0.5 |
| Example 2 | 200V | 0.5 | *1 | 120 | 80 | *2 | 5.0 | 220 | 50 | 0.1 | 0.5 |
| Example 3 | 200V | 0.5 | *1 | 300 | 80 | *2 | 3.0 | 150 | 30 | 0.1 | 0.5 |
| Example 4 | 200V | 0.1 | *1 | 120 | 40 | *2 | 5.0 | 230 | 50 | 0.2 | 0.5 |
| Example 5 | 200V | 0.1 | *1 | 120 | 80 | *2 | 1.0 | 170 | 20 | 0.1 | 0.7 |
| Example 6 | 200V | 0.1 | *1 | 120 | 100 | *2 | 1.0 | 145 | 20 | 0.1 | 0.8 |
| Example 7 | 200V | 0.1 | *1 | 60 | 80 | *2 | 5.0 | 250 | 50 | 0.1 | 0.5 |
| Example 8 | 200V | 0.1 | *1 | 45 | 80 | *2 | 7.0 | 260 | 50 | 0.5 | 0.8 |
| Example 9 | 972V | 0.1 | *1 | 120 | 80 | *2 | 1.0 | 230 | 20 | 0.1 | 0.5 |
| Example 10 | 972V | 0.5 | *1 | 120 | 80 | *2 | 2.0 | 230 | 25 | 0.1 | 0.5 |
| Example 11 | 200V | 0.6 | *1 | 120 | 80 | *2 | 8.0 | 230 | 50 | 0.3 | 0.8 |
| Example 12 | 972V | 0.6 | *1 | 120 | 80 | *2 | 7.0 | 220 | 40 | 0.2 | 0.7 |
| Comp. 1 | 200V | 0.1 | In-line | — | 25 | In-line | — | 250 | 80 | 0.2 | 0.5 |
| Comp. 2 | 200V | 0.1 | *1 | 120 | 25 | *2 | 10.0 | 250 | 70 | 0.1 | 0.4 |
| Comp. 3 | 972V | 0.2 | After the | 60 | 40 | In-line | 10.0 | 240 | 70 | 0.2 | 0.8 |
| | | | dissolving | | | | | | | | |
| | | | of | | | | | | | | |
| | | | cellulose | | | | | | | | |
| | | | ester | | | | | | | | |

*1: During the dissolving of cellulose ester,
*2: Containing in advance
*3: Variation coefficient (%),
*4: Dynamic friction coefficient,
Comp.: Comparative example

As being clear from the results shown in Table 1, in the cellulose triacetate film by Examples 1 to 12 of the present invention, it is recognized that the dispersion in the content of fine particles among film rolls is small, the sliding ability between cellulose triacetate films is good, foreign matters do not occur, and the productivity is also good. Here, as shown in Example 6 of the present invention, if the dissolving and mixing temperature after the adding of a fine particle dispersion liquid into the dissolving tank 4 of cellulose triacetate was high, there are tendencies that the secondary particle size containing fine particles becomes small and the dynamic friction coefficient increases. Further, as shown in Example 8 of the present invention, if the dissolving and mixing time after the adding of a fine particle dispersion liquid into the dissolving tank 4 of cellulose triacetate was short, there are tendencies that the secondary particle size becomes large and the collecting ratio of the secondary fine particles containing silicon dioxide fine particles becomes high. Still further, as shown in Examples 11 and 12 of the present invention, if the additive amount of fine particles to cellulose triacetate in a dope for casting is much, there are tendencies that the secondary particle size becomes large and the collecting ratio of the secondary fine particles containing silicon dioxide fine particles becomes high.

In contrast, in the cellulose triacetate films in Comparative examples 1 to 3, there are defects that any one of the films has a high variation coefficient of the secondary fine particles, the deviation in the content of fine particles for each roll of cellulose triacetate film is large, a convex failure tends to occur as a foreign matter failure, and a sliding ability is also lowered.

1-15. (canceled)

16. A cellulose ester film producing method of producing a film by using a cellulose ester resin solution containing fine particles by a solution casting type film producing method, comprising;
a dissolving process of dissolving cellulose ester resin into a main solvent at a temperature of a boiling point of the main solvent or less under atmospheric pressure so as to form a cellulose ester resin solution,
an adding process of adding fine particles into the cellulose ester resin solution in the dissolving process, and
a mixing process of mixing the cellulose ester resin solution and the fine particles at a temperature of the boiling point or more after the fine particles are added.

17. The cellulose ester film producing method described in claim 16, wherein the mixing of fine particles in the dissolving process is conducted at a temperature between the boiling point of the main solvent and (the boiling point+50° C.).

18. The cellulose ester film producing method described in claim 16, wherein the mixing of fine particles in the dissolving process is conducted for a time period between 60 minutes and 300 minutes.

19. The cellulose ester film producing method described in claim 16, wherein after the fine particles are added, a pressure is added to the cellulose ester resin solution so as to suppress foaming in the mixing process.

20. The cellulose ester film producing method described in claim 16, wherein after the fine particles are added, a pressure of 0.11 to 1.50 MPa is added to the cellulose ester resin solution at a temperature of 40.4 to 120° C. in the mixing process.

21. The cellulose ester film producing method described in claim 16, wherein the fine particles are added during the adding process of the cellulose ester resin into a dissolving tank, after the adding process of the cellulose ester resin, or before the cellulose ester resin is dissolved completely in the dissolving tank.

22. The cellulose ester film producing method described in claim 16, wherein a fine particle dispersion liquid is prepared beforehand so as to contain a compound represented by Formula (1), and subsequently the fine particle dispersion liquid containing the compound is added in the dissolving process of dissolving the cellulose ester resin into the main solvent, 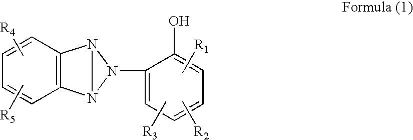
in Formula (1), R₁, R₂, R₃, R₄ and R₅ are the same to or different from each other and each represents substituent selected from a group consisting of a hydrogen atom, a halogen atom, a nitro group, a hydroxyl group, an alkyl group, an alkenyl group, an aryl group, an alkoxy group, an acyloxy group, an aryloxy group, an alkylthio group, an arylthio group, and a mono or di alkylamino group, an acyl amino group, and a five or six member heterocycle group containing oxygen or nitrogen, and R₄ and R₅ may form a five or six member ring composed of carbon atoms and being a closed ring.

23. The cellulose ester film producing method described in claim 16, wherein a fine particle dispersion liquid is prepared beforehand so as to contain the same resin as the cellulose ester resin, and the solid component ratio of the fine particle dispersion liquid is 0.1 to 0.5 times of the solid component ratio of the cellulose ester resin solution in the dissolving process.

24. The cellulose ester film producing method described in claim 16, wherein the fine particles are fine particles incapable of dissolving in the main solvent.

25. The cellulose ester film producing method described in claim 24, wherein the fine particles are silicon dioxide fine particles.

26. The cellulose ester film producing method described in claim 25, wherein the cellulose ester resin solution containing the silicon dioxide fine particles added in the dissolving process is filtered by a filter paper having a colleting particle size of 2.5 μm and a film is formed by the filtered cellulose ester resin solution, and wherein the collecting ratio of secondary fine particles including the silicon dioxide fine particles by the filter paper is 5% or less.

27. A cellulose ester film produced by the cellulose ester film producing method described in claim 16, comprising:
a cellulose ester film; and
fine particles;
wherein the variation coefficient of fine particles (average particle diameter/standard deviation) in a cross section of a cut-out piece of the cellulose ester film is 50% or less in a particle diameter measurement of fine particles by the use of a transmission electron microscope.

28. The cellulose ester film described in claim 27, wherein the variation coefficient is 30% or less.

29. The cellulose ester film described in claim 27, wherein the particle diameter measurement is a measurement for secondary fine particles, and wherein a primary particle diameter is 20 nm or less and a secondary particle diameter is 150 nm to 250 nm.

30. The cellulose ester film described in claim 27, wherein the haze of the cellulose ester film is 0 to 0.5% and the dynamic friction coefficient on the back side surface of the cellulose ester film is 0.5 to 0.7.
